(19) United States
(12) Patent Application Publication
(10) Pub. No.: US 2023/0133605 A1
(43) Pub. Date: May 4, 2023

(54) OPTICAL IMAGING LENS

(71) Applicant: Calin Technology Co., Ltd., Taichung City (TW)

(72) Inventor: FUN-RU LIN, Taichung City (TW)

(73) Assignee: Calin Technology Co., Ltd., Taichung City (TW)

(21) Appl. No.: 17/842,008

(22) Filed: Jun. 16, 2022

(30) Foreign Application Priority Data
Nov. 1, 2021 (TW) 110140575

(51) Int. Cl. G02B 13/00; G02B 9/64

(52) U.S. Cl. CPC G02B 13/0045; G02B 9/64

(57) ABSTRACT

An optical imaging lens, in order from an object side to an image side along an optical axis, includes a first lens assembly, an aperture, and a second lens assembly. The first lens assembly includes a first optical assembly having negative refractive power, a second optical assembly having negative refractive power, a third optical assembly having positive refractive power. The second lens assembly includes a fourth optical assembly having positive refractive power and a fifth optical assembly having positive refractive power. Two of the first optical assembly, the second optical assembly, the third optical assembly, the fourth optical assembly, and the fifth optical assembly are a compound lens formed by adhering at least two lenses, while the others are single lenses, thereby achieving the effect of high image quality.

### BACKGROUND OF THE INVENTION

### Technical Field

The present invention generally relates to an optical image capturing system, and more particularly to an optical imaging lens, which provides a better optical performance of high image quality and low distortion.

### Description of Related Art

In recent years, with advancements in portable electronic devices having camera functionalities, the demand for an optical image capturing system is raised gradually. The image sensing device of the ordinary photographing camera is commonly selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role, collecting environmental information through various lenses and sensors to ensure the driving safety of the driver. Furthermore, as the image quality of the automotive lens changes with the temperature of an external application environment, the temperature requirements of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides a better optical performance of high image quality.

The present invention provides an optical imaging lens, in order from an object side to an image side along an optical axis, including a first lens assembly, an aperture, and a second lens assembly, wherein the first lens assembly includes, in order from the object side to the image side along the optical axis, a first optical assembly having negative refractive power, a second optical assembly having negative refractive power, and a third optical assembly having positive refractive power. The second lens assembly includes, in order from the object side to the image side along the optical axis, a fourth optical assembly having positive refractive power and a fifth optical assembly having positive refractive power. Two of the first optical assembly, the second optical assembly, the third optical assembly, the fourth optical assembly, and the fifth optical assembly include a compound lens formed by adhering at least two lenses, while the others are single lenses.

The present invention further provides an optical imaging lens, in order from an object side to an image side along an optical axis, includes a first lens having negative refractive power, a second lens having negative refractive power, a third lens having positive refractive power, an aperture, a fourth lens having positive refractive power, a fifth lens having negative refractive power, a sixth lens having positive refractive power, and a seventh lens having positive refractive power. An object-side surface of the first lens and/or an image-side surface of the first lens are/is an aspheric surface. The second lens is a biconcave lens. An object-side surface of the third lens and an image-side surface of the second lens are adhered to form a compound lens. An object-side surface of the fifth lens is a convex surface, and an image-side surface of the fifth lens is a concave surface. The sixth lens is a biconvex lens. An object-side surface of the seventh lens and/or an image-side surface of the seventh lens are/is an aspheric surface.

With the aforementioned design, the optical imaging lens has a total of seven lenses to form five groups of optical assemblies, wherein two of the optical assemblies include a compound lenses formed by adhering at least two of the lenses, while the others are single lenses, which could effectively improve a chromatic aberration of the optical imaging lens. In addition, the arrangement of the refractive powers and the conditions of the optical imaging lens of the present invention could achieve the effect of high image quality.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the longitudinal spherical aberration of the optical imaging lens according to the first embodiment of the present invention;

FIG. 1C is a diagram showing the lateral spherical aberration of the optical imaging lens according to the first embodiment of the present invention;

FIG. 2A is a schematic view of the optical imaging lens according to a second embodiment of the present invention;

FIG. 2B is a diagram showing the longitudinal spherical aberration of the optical imaging lens according to the second embodiment of the present invention;

FIG. 2C is a diagram showing the lateral spherical aberration of the optical imaging lens according to the second embodiment of the present invention;

FIG. 3A is a schematic view of the optical imaging lens according to a third embodiment of the present invention;

FIG. 3B is a diagram showing the longitudinal spherical aberration of the optical imaging lens according to the third embodiment of the present invention; and

FIG. 3C is a diagram showing the lateral spherical aberration of the optical imaging lens according to the third embodiment of the present invention.

### DETAILED DESCRIPTION OF THE INVENTION

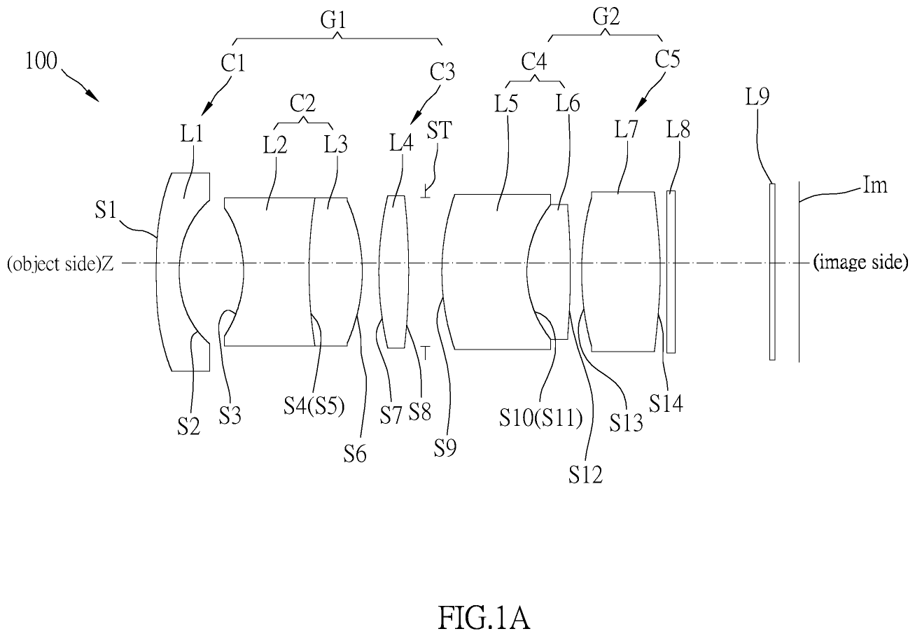

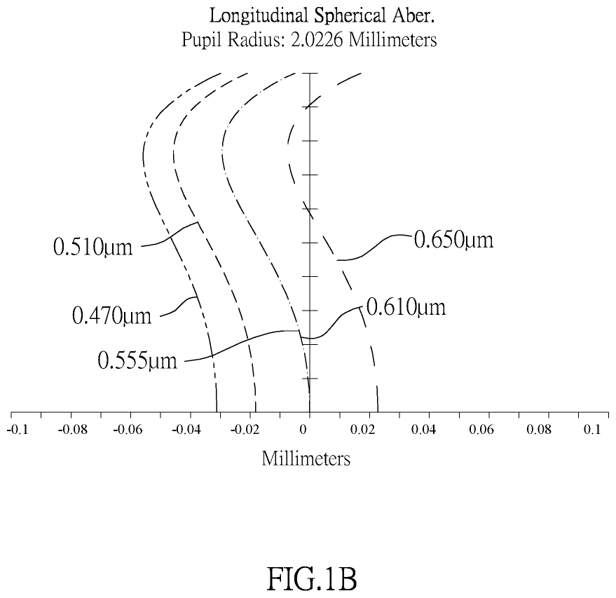

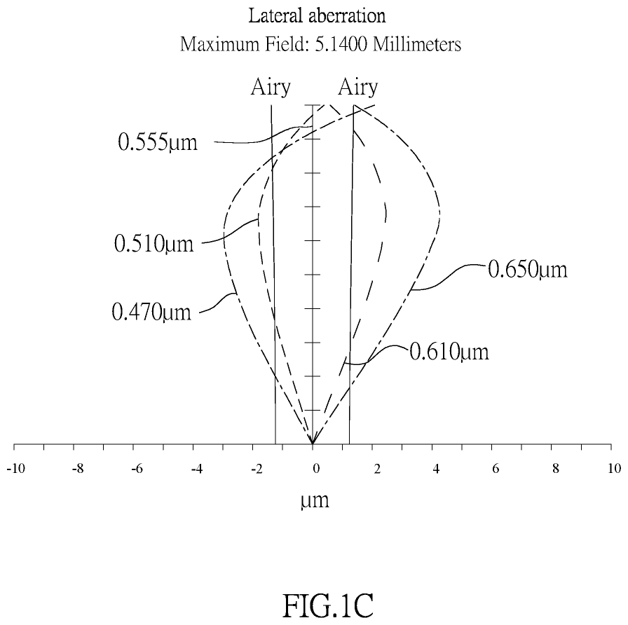

An optical imaging lens 100 according to a first embodiment of the present invention is illustrated in FIG. 1A, which includes, in order along an optical axis Z from an object side to an image side, a first lens assembly G1, an aperture ST, and a second lens assembly G2. In the current embodiment, the first lens assembly G1 includes, in order along the optical axis Z from the object side to the image side, a first optical assembly C1, a second optical assembly C2, and a third optical assembly C3; the second lens assembly G2 includes, in order along the optical axis Z from the object side to the image side, a fourth optical assembly C4 and a fifth optical assembly C5, wherein two of the first optical assembly, the second optical assembly, the third optical assembly, the fourth optical assembly, and the fifth optical assembly include a compound lens with at least two lenses that are adhered, while the others are single lenses.

The first optical assembly C1 has negative refractive power. In the current embodiment, the first optical assembly C1 is a single lens that includes a first lens L1, wherein the first lens L1 is a negative meniscus; an object-side surface S1 of the first lens L1 is a convex surface toward the object side, and an image-side surface S2 of the first lens L1 is a concave surface toward the image side; the object-side surface S1, the image-side surface S2, or both of the object-side surface S1 and the image-side surface S2 of the first lens L1 are aspheric surfaces. As shown in FIG. 1A, both of the object-side surface S1 and the image-side surface S2 of the first lens L1 are aspheric surfaces, and a part of a surface of the first lens L1 toward the image side is recessed to form the image-side surface S2, and the optical axis Z passes through the object-side surface S1 and the image-side surface S2 of the first lens L1.

The second optical assembly C2 has negative refractive power. In the current embodiment, the second optical assembly C2 is a compound lens formed by adhering a second lens L2 and a third lens L3, which could effectively improve a chromatic aberration of the optical imaging lens 100, wherein the second lens L2 is a biconcave lens with negative refractive power (i.e., both of an object-side surface S3 of the second lens L2 and an image-side surface S4 of the second lens L2 are concave surfaces). The third lens is a biconvex lens (i.e., both of an object-side surface S5 of the third lens L3 and an image-side surface S6 of the third lens L3 are convex surfaces) with positive refractive power. As shown in FIG. 1A, the object-side surface S5 of the third lens L3 and the image-side surface S4 of the second lens L2 are adhered to form a same surface.

The third optical assembly C3 has positive refractive power. In the current embodiment, the third optical assembly C3 is a single lens that includes a fourth lens L4, wherein the fourth lens L4 is a biconvex lens (i.e., both of an object-side surface S7 of the fourth lens L4 and an image-side surface S8 of the fourth lens L4 are convex surfaces) with positive refractive power.

The fourth optical assembly C4 has positive refractive power. In the current embodiment, the fourth optical assembly C4 is a compound lens formed by adhering a fifth lens L5 and a sixth lens L6, wherein the fifth lens L5 is a negative meniscus; an object-side surface S9 of the fifth lens L5 is a convex surface toward the object side, and an image-side surface S10 of the fifth lens L5 is a concave surface toward the image side. As shown in FIG. 1A, a part of a surface of the fifth lens L5 toward the image side is recessed to form the image-side surface S10, and the optical axis Z passes through the object-side surface S9 and the image-side surface S10 of the fifth lens L5. The sixth lens L6 is a biconvex lens (i.e., both of an object-side surface Sl1 of the sixth lens L6 and an image-side surface S12 of the sixth lens L6 are convex surfaces) with positive refractive power, wherein the object-side surface S11 of the sixth lens L6 and the image-side surface S10 of the fifth lens L5 are adhered to form a same surface.

The fifth optical assembly C5 has positive refractive power. In the current embodiment, the fifth optical assembly C5 is a single lens that includes a seventh lens L7, wherein the seventh lens L7 is a biconvex lens (i.e., both of an object-side surface S13 of the seventh lens L7 and an image-side surface S14 of the seventh lens L7 are convex surfaces) with positive refractive power; the object-side surface S13, the image-side surface S14, or both of the object-side surface S13 and the image-side surface S14 of the seventh lens L7 are aspheric surfaces. As shown in FIG. 1A, both of the object-side surface S13 and the image-side surface S14 of the seventh lens L7 are aspheric surfaces.

Additionally, the optical imaging lens 100 further includes an infrared filter L8 and a protective glass L9, wherein the infrared filter L8 is disposed between the seventh lens L7 and the protective glass L9 and is closer to the image-side surface S14 of the seventh lens L7 than the protective glass L9, thereby filtering out excess infrared rays in an image light passing through the first lens assembly G1 and the second lens assembly G2 to improve imaging quality. The protective glass L9 for protecting the infrared filter L8 is disposed between the infrared filter L8 and an image plane Im of the optical imaging lens 100 and is closer to the image plane Im than the infrared filter L8.

In order to keep the optical imaging lens 100 in good optical performance and high imaging quality, the optical imaging lens 100 further satisfies:

−0.6<F/f1<−0.4; (1)

−0.25<F/f23<−0.1; 0.6<F/f3<0.9; (2)

0.3<F/f4<0.5; (3)

0.01<F/f56<0.15; 0.55<F/f6<0.7; (4)

0.3<F/f7<0.5; (5)

0.2<F/fg1<0.4; 0.3<F/fg2<0.5; (6)

wherein F is a focal length of the optical imaging lens 100; f1 is a focal length of the first lens L1 of the first optical assembly C1; f2 is a focal length of the second lens L2 of the second optical assembly C2; f3 is a focal length of the third lens L3 of the second optical assembly C2; f23 is a focal length of the second optical assembly C2; f4 is a focal length of the fourth lens L4 of the third optical assembly C3; f5 is a focal length of the fifth lens L5 of the fourth optical assembly C4; f6 is a focal length of the sixth lens L6 of the fourth optical assembly C4; f56 is a focal length of the fourth optical assembly C4; f7 is a focal length of the seventh lens L7 of the fifth optical assembly C5; fg1 is a focal length of the first lens assembly G1; fg2 is a focal length of the second lens assembly G2.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (HFOV), a radius of curvature (R) of each lens, a distance (D) between each surface and the next surface on the optical axis Z, a refractive index (Nd) of each lens, an Abbe number (Vd) of each lens, the focal length of each lens, the focal length (cemented focal length) of the second optical assembly C2, and the focal length (cemented focal length) of the fourth optical assembly C4, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 1
F = 7.02 mm; Fno = 1.8; HFOV = 85 deg

| | | | | | | Cemented | |
|---|---|---|---|---|---|---|---|
| | R | D | | | Focal | focal | |
| Surface | (mm) | (mm) | Nd | Vd | length | length | Note |
| S1 | 48.29 | 1.38 | 1.55 | 63.45 | −15.59 | | L1 |
| S2 | 7.25 | 3.88 | | | | | |
| S3 | −6.88 | 3.94 | 1.91 | 35.04 | −5.75 | −34.95 | L2 |
| S4, S5 | 27.73 | 3.21 | 1.79 | 44.2 | 10.41 | | L3 |
| S6 | −10.39 | 1.00 | | | | | |
| S7 | 19.51 | 1.79 | 1.70 | 51.11 | 18.91 | | L4 |
| S8 | −39.92 | 1.00 | | | | | |
| ST | Infinity | 1.00 | | | | | ST |
| S9 | 14.14 | 5.12 | 1.96 | 17.47 | −17.38 | 65.26 | L5 |
| S10, | 6.30 | 2.62 | 1.44 | 94.95 | 11.47 | | L6 |
| S11 | | | | | | | |
| S12 | −43.92 | 0.68 | | | | | |
| S13 | 18.00 | 4.73 | 1.50 | 81.55 | 21.09 | | L7 |
| S14 | 21.95 | 0.40 | | | | | |
| S15 | Infinity | 0.5 | 1.52 | 58.57 | | | Infrared |
| | | | | | | | filter L8 |
| S16 | Infinity | 5.7 | | | | | |
| S17 | Infinity | 0.3 | 1.52 | 58.57 | | | Protective |
| | | | | | | | glass L9 |
| S18 | Infinity | 1.46 | | | | | |
| Im | Infinity | | | | | | Im |

It can be seen from Table 1 that, in the current embodiment, the focal length F of the optical imaging lens 100 is 7.02 mm, and the Fno is 1.8, and the HFOV is 85 degrees, wherein f1=−15.59 mm; f2=−5.75 mm; f3=10.41 mm; f4=18.91 mm; f5=−17.38 mm; f6=11.47 mm; f7=21.09 mm; f23=−34.95 mm; f56=65.26 mm; fg1=26.99 mm; fg2=19.13 mm.

Additionally, based on the above detailed parameters, detailed values of the aforementioned conditional formula in the first embodiment are as follows: F/f1=−0.45; F/f23=−0.2; F/f3=0.67; F/f4=0.37; F/f56=0.11; F/f6=0.61; F/f7=0.33; F/fg1=0.26; F/fg2=0.37.

With the aforementioned design, the first optical assembly C1 to the fifth optical assembly C5 satisfy the aforementioned conditions (1) to (6) of the optical imaging lens 100.

Moreover, an aspheric surface contour shape Z of each of the object-side surface S1 of the first lens L1, and the image-side surface S2 of the first lens L1, and the object-side surface S13 of the seventh lens L7, and the image-side surface S14 of the seventh lens L7 of the optical imaging lens 100 according to the first embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, and the image-side surface S2 of the first lens L1, and the object-side surface S13 of the seventh lens L7, and the image-side surface S14 of the seventh lens L7 of the optical imaging lens 100 according to the first embodiment and the different order coefficient of A4, A6, A8, A10, A12, A14, and A16 are listed in following Table 2:

TABLE 2

| Surface | S1 | S2 | S13 | S14 |
|---|---|---|---|---|
| k | 0 | 0 | 0 | 0 |
| A4 | 1.0780E−03 | 1.0610E−03 | −1.5390E−06 | 3.4950E−04 |
| A6 | −2.4600E−05 | −2.1440E−05 | −7.2380E−06 | 4.2260E−06 |
| A8 | −1.6560E−06 | −3.6900E−06 | 7.7990E−07 | −4.6410E−07 |
| A10 | 2.0000E−08 | 3.1360E−07 | 2.6600E−08 | 9.6610E−10 |
| A12 | −1.7320E−12 | −1.6100E−08 | −9.4650E−10 | −1.6040E−12 |
| A14 | 2.4120E−12 | 8.8740E−11 | 5.3150E−12 | 7.6140E−15 |
| A16 | 0 | 0 | 0 | 0 |

Taking optical simulation data to verify the imaging quality of the optical imaging lens 100, wherein FIG. 1B is a diagram showing the longitudinal spherical aberration according to the first embodiment; FIG. 1C is a diagram showing the lateral spherical aberration according to the first embodiment. The graphics shown in FIG. 1B and FIG. 1C are within a standard range. In this way, the optical imaging lens 100 of the first embodiment could effectively enhance image quality.

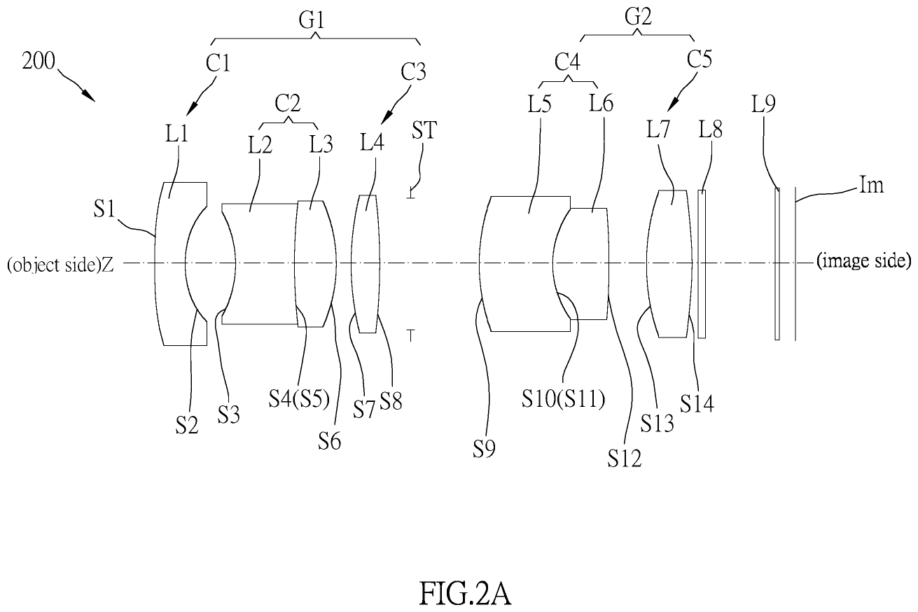

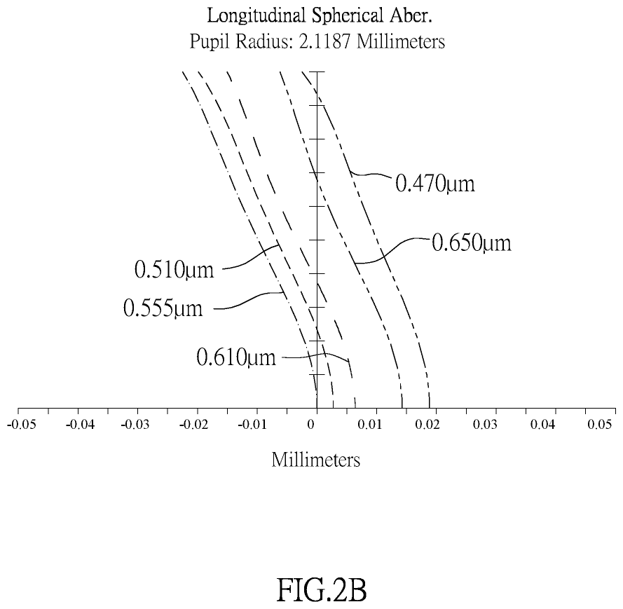

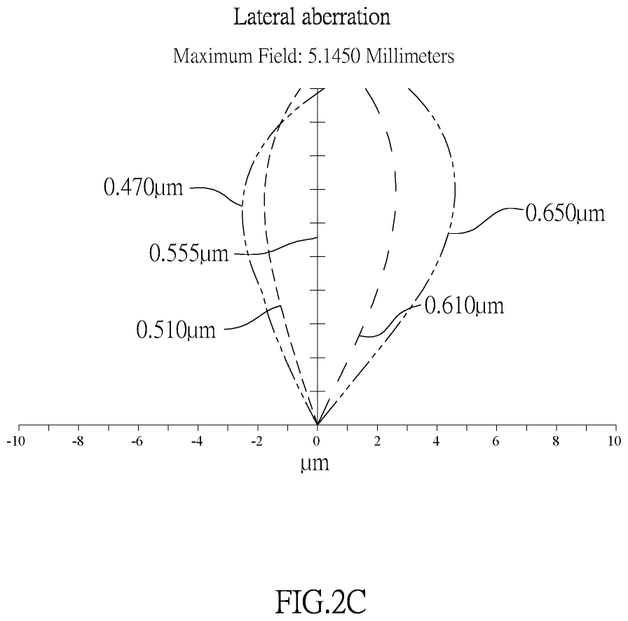

An optical imaging lens 200 according to a second embodiment of the present invention is illustrated in FIG. 2A, which includes, in order along an optical axis Z from an object side to an image side, a first lens assembly G1, an aperture ST, and a second lens assembly G2. In the current embodiment, the first lens assembly G1 includes, in order along the optical axis Z from the object side to the image side, a first optical assembly C1, a second optical assembly C2, and a third optical assembly C3; the second lens assembly G2 includes, in order along the optical axis Z from the object side to the image side, a fourth optical assembly C4 and a fifth optical assembly C5.

The first optical assembly C1 has negative refractive power. In the current embodiment, the first optical assembly C1 is a single lens that includes a first lens L1, wherein the first lens L1 is a negative meniscus; an object-side surface S1 of the first lens L1 is a convex surface toward the object side, and an image-side surface S2 of the first lens L1 is a concave surface toward the image side; the object-side surface S1, the image-side surface S2, or both of the object-side surface S1 and the image-side surface S2 of the first lens L1 are aspheric surfaces. As shown in FIG. 2A, both of the object-side surface S1 and the image-side surface S2 of the first lens L1 are aspheric surfaces, and a part of a surface of the first lens L1 toward the image side is recessed to form the image-side surface S2, and the optical axis Z passes through the object-side surface S1 and the image-side surface S2 of the first lens L1.

The second optical assembly C2 has negative refractive power. In the current embodiment, the second optical assembly C2 is a compound lens formed by adhering a second lens L2 and a third lens L3, which could effectively improve a chromatic aberration of the optical imaging lens 100, wherein the second lens L2 is a biconcave lens with negative refractive power (i.e., both of an object-side surface S3 of the second lens L2 and an image-side surface S4 of the second lens L2 are concave surfaces). The third lens is a biconvex lens (i.e., both of an object-side surface S5 of the third lens L3 and an image-side surface S6 of the third lens L3 are convex surfaces) with positive refractive power. As shown in FIG. 2A, the object-side surface S5 of the third lens L3 and the image-side surface S4 of the second lens L2 are adhered to form a same surface.

The third optical assembly C3 has positive refractive power. In the current embodiment, the third optical assembly C3 is a single lens that includes a fourth lens L4, wherein the fourth lens L4 is a biconvex lens (i.e., both of an object-side surface S7 of the fourth lens L4 and an image-side surface S8 of the fourth lens L4 are convex surfaces) with positive refractive power.

The fourth optical assembly C4 has positive refractive power. In the current embodiment, the fourth optical assembly C4 is a compound lens formed by adhering a fifth lens L5 and a sixth lens L6, wherein the fifth lens L5 is a negative meniscus; an object-side surface S9 of the fifth lens L5 is a convex surface toward the object side, and an image-side surface S10 of the fifth lens L5 is a concave surface toward the image side. As shown in FIG. 2A, a part of a surface of the fifth lens L5 toward the image side is recessed to form the image-side surface S10, and the optical axis Z passes through the object-side surface S9 and the image-side surface S10 of the fifth lens L5. The sixth lens L6 is a biconvex lens (i.e., both of an object-side surface Sl1 of the sixth lens L6 and an image-side surface S12 of the sixth lens L6 are convex surfaces) with positive refractive power, wherein the object-side surface S11 of the sixth lens L6 and the image-side surface S10 of the fifth lens L5 are adhered to form a same surface.

The fifth optical assembly C5 has positive refractive power. In the current embodiment, the fifth optical assembly C5 is a single lens that includes a seventh lens L7, wherein the seventh lens L7 is a biconvex lens (i.e., both of an object-side surface S13 of the seventh lens L7 and an image-side surface S14 of the seventh lens L7 are convex surfaces) with positive refractive power; the object-side surface S13, the image-side surface S14, or both of the object-side surface S13 and the image-side surface S14 of the seventh lens L7 are aspheric surfaces. As shown in FIG. 2A, both of the object-side surface S13 and the image-side surface S14 of the seventh lens L7 are aspheric surfaces.

Additionally, the optical imaging lens 200 further includes an infrared filter L8 and a protective glass L9, wherein the infrared filter L8 is disposed between the seventh lens L7 and the protective glass L9 and is closer to the image-side surface S14 of the seventh lens L7 than the protective glass L9, thereby filtering out excess infrared rays in an image light passing through the first lens assembly G1 and the second lens assembly G2 to improve imaging quality. The protective glass L9 for protecting the infrared filter L8 is disposed between the infrared filter L8 and an image plane Im of the optical imaging lens 200 and is closer to the image plane Im than the infrared filter L8.

In order to keep the optical imaging lens 200 in good optical performance and high imaging quality, the optical imaging lens 200 further satisfies:

−0.6<F/f1<−0.4; (1)

−0.25<F/f23<−0.1; 0.6<F/f3<0.9; (2)

0.3<F/f4<0.5; (3)

0.01<F/f56<0.15; 0.55<F/f6<0.7; (4)

0.3<F/f7<0.5; (5)

0.2<F/fg1<0.4; 0.3<F/fg2<0.5; (6)

wherein F is a focal length of the optical imaging lens 200; f1 is a focal length of the first lens L1 of the first optical assembly C1; f2 is a focal length of the second lens L2 of the second optical assembly C2; f3 is a focal length of the third lens L3 of the second optical assembly C2; f23 is a focal length of the second optical assembly C2; f4 is a focal length of the fourth lens L4 of the third optical assembly C3; f5 is a focal length of the fifth lens L5 of the fourth optical assembly C4; f6 is a focal length of the sixth lens L6 of the fourth optical assembly C4; f56 is a focal length of the fourth optical assembly C4; f7 is a focal length of the seventh lens L7 of the fifth optical assembly C5; fg1 is a focal length of the first lens assembly G1; fg2 is a focal length of the second lens assembly G2.

Parameters of the optical imaging lens 200 of the second embodiment of the present invention are listed in following Table 3, including the focal length F of the optical imaging lens 200 (also called an effective focal length (EFL)), a F-number (Fno), a maximal field of view (HFOV), a radius of curvature (R) of each lens, a distance (D) between each surface and the next surface on the optical axis Z, a refractive index (Nd) of each lens, an Abbe number (Vd) of each lens, the focal length of each lens, the focal length (cemented focal length) of the second optical assembly C2, and the focal length (cemented focal length) of the fourth optical assembly C4, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 3
F = 7.75 mm; Fno = 1.9; HFOV = 73.9 deg

| | | | | | | Cemented | |
|---|---|---|---|---|---|---|---|
| | R | D | | | Focal | focal | |
| Surface | (mm) | (mm) | Nd | Vd | length | length | Note |
| S1 | 84.4 | 2.054 | 1.59 | 60.99 | −13.26 | | L1 |
| S2 | 7.14 | 3.4 | | | | | |
| S3 | −7.25 | 3.97 | 1.91 | 32.36 | −7.65 | −59.124 | L2 |
| S4, S5 | 36.52 | 2.82 | 1.8 | 42.24 | 10.32 | | L3 |
| S6 | −10.35 | 1 | | | | | |
| S7 | 19.13 | 1.93 | 1.69 | 50.81 | 18.97 | | L4 |
| S8 | −40.82 | 2.09 | | | | | |
| ST | Infinity | 4.62 | | | | | ST |
| S9 | 13.19 | 4.96 | 1.96 | 17.47 | −19.35 | 64.18 | L5 |
| S10, | 6.31 | 3.8 | 1.46 | 67.83 | 12.37 | | L6 |
| S11 | | | | | | | |
| S12 | −46.35 | 2.53 | | | | | |
| S13 | 16.19 | 3.07 | 1.5 | 61.44 | 19.46 | | L7 |
| S14 | −23.02 | 0.4 | | | | | |
| S15 | Infinity | 0.5 | 1.52 | 58.57 | | | Infrared |
| | | | | | | | filter L8 |
| S16 | Infinity | 4.7 | | | | | |
| S17 | Infinity | 0.3 | 1.52 | 58.57 | | | Protective |
| | | | | | | | glass L9 |
| S18 | Infinity | 1.07 | | | | | |
| Im | Infinity | | | | | | Im |

It can be seen from Table 3 that, in the second embodiment, the focal length (F) of the optical imaging lens 200 is 7.75 mm, and the Fno is 1.9, and the HFOV is 73.9 degrees, wherein f1=−13.26 mm; f2=−7.65 mm; f3=10.32 mm; f4=18.97 mm; f5=−19.35 mm; f6=12.37 mm; f7=19.46 mm; f23=−59.124 mm; f56=64.18 mm; fg1=24.52; fg2=18.61 mm.

Additionally, based on the above detailed parameters, detailed values of the aforementioned conditional formula in the second embodiment are as follows: F/f1=−0.58; F/f23=−0.13; F/f3=0.75; F/f4=0.41; F/f56=0.12; F/f6=0.63; F/f7=0.4; F/fg1=0.32; F/fg2=0.42.

With the aforementioned design, the first optical assembly C1 to the fifth optical assembly C5 satisfy the aforementioned conditions (1) to (6) of the optical imaging lens 200.

Moreover, an aspheric surface contour shape Z of each of the object-side surface S1 of the first lens L1, and the image-side surface S2 of the first lens L1, and the object-side surface S13 of the seventh lens L7, and the image-side surface S14 of the seventh lens L7 of the optical imaging lens 200 according to the second embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, and the image-side surface S2 of the first lens L1, and the object-side surface S13 of the seventh lens L7, and the image-side surface S14 of the seventh lens L7 of the optical imaging lens 200 according to the second embodiment and the different order coefficient of A4, A6, A8, A10, A12, A14, and A16 are listed in following Table 4:

TABLE 4

| Surface | S1 | S2 | S13 | S14 |
|---|---|---|---|---|
| k | 0 | 0 | 0 | 0 |
| A4 | −3.1844E−04 | −3.1891E−04 | −3.3727E−04 | 1.3648E−05 |
| A6 | 1.7436E−05 | 1.6907E−05 | −1.9030E−05 | −2.0925E−06 |
| A8 | −2.8039E−06 | −2.5809E−06 | 1.2667E−06 | 1.1162E−07 |
| A10 | 1.8341E−07 | 1.4747E−07 | −1.0762E−07 | −4.1976E−09 |
| A12 | −8.1643E−09 | −5.4250E−09 | 4.3003E−09 | 9.5607E−11 |
| A14 | 2.0856E−10 | 1.0915E−10 | −8.7551E−11 | −1.3367E−12 |
| A16 | −2.6320E−12 | −1.2435E−12 | 6.5127E−13 | −5.8943E−11 |

Taking optical simulation data to verify the imaging quality of the optical imaging lens 200, wherein FIG. 2B is a diagram showing the longitudinal spherical aberration according to the second embodiment; FIG. 2C is a diagram showing the lateral spherical aberration according to the second embodiment. The graphics shown in FIG. 2B and FIG. 2C are within a standard range. In this way, the optical imaging lens 200 of the second embodiment could effectively enhance image quality.

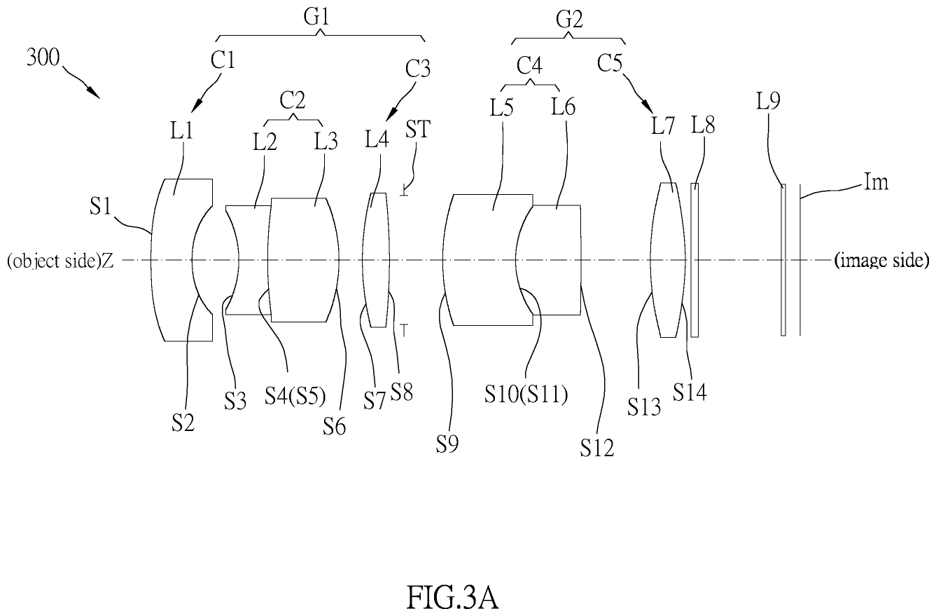

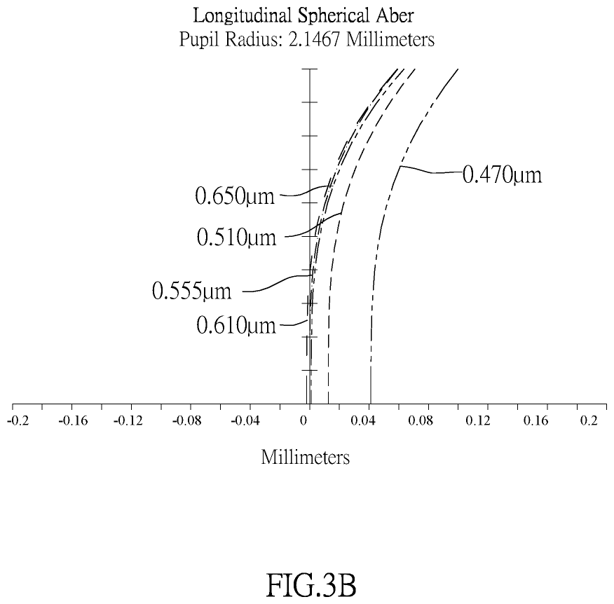

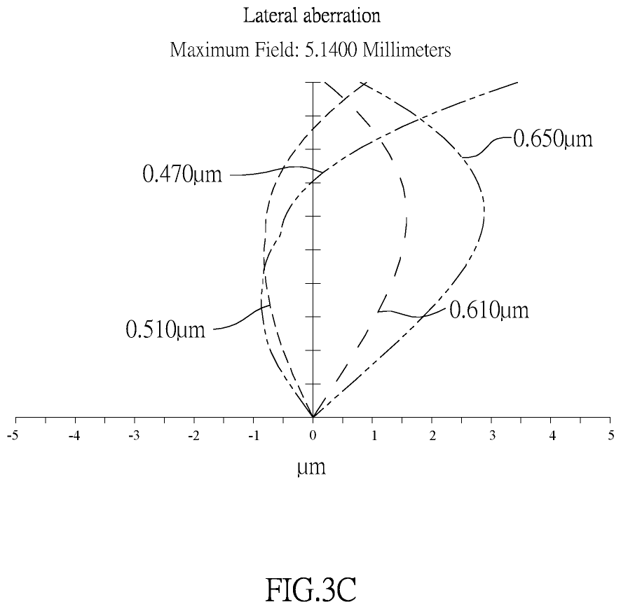

An optical imaging lens 300 according to a third embodiment of the present invention is illustrated in FIG. 3A, which includes, in order along an optical axis Z from an object side to an image side, a first lens assembly G1, an aperture ST, and a second lens assembly G2. In the current embodiment, the first lens assembly G1 includes, in order along the optical axis Z from the object side to the image side, a first optical assembly C1, a second optical assembly C2, and a third optical assembly C3; the second lens assembly G2 includes, in order along the optical axis Z from the object side to the image side, a fourth optical assembly C4 and a fifth optical assembly C5.

The first optical assembly C1 has negative refractive power. In the current embodiment, the first optical assembly C1 is a single lens that includes a first lens L1, wherein the first lens L1 is a negative meniscus; an object-side surface S1 of the first lens L1 is a convex surface toward the object side, and an image-side surface S2 of the first lens L1 is a concave surface toward the image side; the object-side surface S1, the image-side surface S2, or both of the object-side surface S1 and the image-side surface S2 of the first lens L1 are aspheric surfaces. As shown in FIG. 3A, both of the object-side surface S1 and the image-side surface S2 of the first lens L1 are aspheric surfaces, and a part of a surface of the first lens L1 toward the image side is recessed to form the image-side surface S2, and the optical axis Z passes through the object-side surface S1 and the image-side surface S2 of the first lens L1.

The second optical assembly C2 has negative refractive power. In the current embodiment, the second optical assembly C2 is a compound lens formed by adhering a second lens L2 and a third lens L3, which could effectively improve a chromatic aberration of the optical imaging lens 100, wherein the second lens L2 is a biconcave lens with negative refractive power (i.e., both of an object-side surface S3 of the second lens L2 and an image-side surface S4 of the second lens L2 are concave surfaces). The third lens is a biconvex lens (i.e., both of an object-side surface S5 of the third lens L3 and an image-side surface S6 of the third lens L3 are convex surfaces) with positive refractive power. As shown in FIG. 3A, the object-side surface S5 of the third lens L3 and the image-side surface S4 of the second lens L2 are adhered to form a same surface.

The third optical assembly C3 has positive refractive power. In the current embodiment, the third optical assembly C3 is a single lens that includes a fourth lens L4, wherein the fourth lens L4 is a biconvex lens (i.e., both of an object-side surface S7 of the fourth lens L4 and an image-side surface S8 of the fourth lens L4 are convex surfaces) with positive refractive power.

The fourth optical assembly C4 has positive refractive power. In the current embodiment, the fourth optical assembly C4 is a compound lens formed by adhering a fifth lens L5 and a sixth lens L6, wherein the fifth lens L5 is a negative meniscus, wherein an object-side surface S9 of the fifth lens L5 is a convex surface toward the object side, and an image-side surface S10 of the fifth lens L5 is a concave surface toward the image side, and the optical axis Z passes through the object-side surface S9 and the image-side surface S10 of the fifth lens L5. The sixth lens L6 is a biconvex lens (i.e., both of an object-side surface S11 of the sixth lens L6 and an image-side surface S12 of the sixth lens L6 are convex surfaces) with positive refractive power, wherein the object-side surface S11 of the sixth lens L6 and the image-side surface S10 of the fifth lens L5 are adhered to form a same surface.

The fifth optical assembly C5 has positive refractive power. In the current embodiment, the fifth optical assembly C5 is a single lens that includes a seventh lens L7, wherein the seventh lens L7 is a biconvex lens (i.e., both of an object-side surface S13 of the seventh lens L7 and an image-side surface S14 of the seventh lens L7 are convex surfaces) with positive refractive power; the object-side surface S13, the image-side surface S14, or both of the object-side surface S13 and the image-side surface S14 of the seventh lens L7 are aspheric surfaces. As shown in FIG. 3A, both of the object-side surface S13 and the image-side surface S14 of the seventh lens L7 are aspheric surfaces.

Additionally, the optical imaging lens 300 further includes an infrared filter L8 and a protective glass L9, wherein the infrared filter L8 is disposed between the seventh lens L7 and the protective glass L9 and is closer to the image-side surface S14 of the seventh lens L7 than the protective glass L9. The protective glass L9 for protecting the infrared filter L8 is disposed between the infrared filter L8 and an image plane Im of the optical imaging lens 300 and is closer to the image plane Im than the infrared filter L8.

In order to keep the optical imaging lens 300 in good optical performance and high imaging quality, the optical imaging lens 300 further satisfies:

−0.6<F/f1<−0.4; (1)

−0.25<F/f23<−0.1; 0.6<F/f3<0.9; (2)

0.3<F/f4<0.5; (3)

0.01<F/f56<0.15; 0.55<F/f6<0.7; (4)

0.3<F/f7<0.5; (5)

0.2<F/fg1<0.4; 0.3<F/fg2<0.5; (6)

wherein F is a focal length of the optical imaging lens 300; f1 is a focal length of the first lens L1 of the first optical assembly C1; f2 is a focal length of the second lens L2 of the second optical assembly C2; f3 is a focal length of the third lens L3 of the second optical assembly C2; f23 is a focal length of the second optical assembly C2; f4 is a focal length of the fourth lens L4 of the third optical assembly C3; f5 is a focal length of the fifth lens L5 of the fourth optical assembly C4; f6 is a focal length of the sixth lens L6 of the fourth optical assembly C4; f56 is a focal length of the fourth optical assembly C4; f7 is a focal length of the seventh lens L7 of the fifth optical assembly C5; fg1 is a focal length of the first lens assembly G1; fg2 is a focal length of the second lens assembly G2.

Parameters of the optical imaging lens 300 of the third embodiment of the present invention are listed in following Table 5, including the focal length F of the optical imaging lens 300 (also called an effective focal length (EFL)), a F-number (Fno), a maximal field of view (HFOV), a radius of curvature (R) of each lens, a distance (D) between each surface and the next surface on the optical axis Z, a refractive index (Nd) of each lens, an Abbe number (Vd) of each lens, the focal length of each lens, the focal length (cemented focal length) of the second optical assembly C2, and the focal length (cemented focal length) of the fourth optical assembly C4, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 5
F = 8.7 mm; Fno = 2.1; HFOV = 62 deg

| | | | | | | Cemented | |
|---|---|---|---|---|---|---|---|
| | R | D | | | Focal | focal | |
| Surface | (mm) | (mm) | Nd | Vd | length | length | Note |
| S1 | 38.31 | 2.82 | 1.53 | 62.15 | −16.09 | | L1 |
| S2 | 6.82 | 3.23 | | | | | |
| S3 | −6.85 | 1.98 | 1.91 | 35.04 | −7.31 | −50.76 | L2 |
| S4, S5 | 28.19 | 4.91 | 1.81 | 40.4 | 9.97 | | L3 |
| S6 | −10.43 | 1.61 | | | | | |
| S7 | 18.33 | 1.86 | 1.66 | 50.88 | 19.59 | | L4 |
| S8 | −42.26 | 1 | | | | | |
| ST | Infinity | 2.67 | | | | | ST |
| S9 | 13.76 | 5.02 | 1.96 | 17.47 | −18.61 | 151.93 | L5 |
| S10, | 6.41 | 4.5 | 1.45 | 90.29 | 13.69 | | L6 |
| S11 | | | | | | | |
| S12 | −206.83 | 4.78 | | | | | |
| S13 | 20.43 | 2.4 | 1.51 | 62.57 | 18.45 | | L7 |
| S14 | −16.94 | 0.4 | | | | | |
| S15 | Infinity | 0.5 | 1.52 | 58.57 | | | Infrared |
| | | | | | | | filter L8 |
| S16 | Infinity | 4.7 | | | | | |
| S17 | Infinity | 0.3 | 1.52 | 58.57 | | | Protective |
| | | | | | | | glass L9 |
| S18 | Infinity | 1.07 | | | | | |
| Im | Infinity | | | | | | Im |

It can be seen from Table 5 that, in the current embodiment, the focal length F of the optical imaging lens 300 is 8.7 mm, and the Fno is 2.1, and the HFOV is 62 degrees, wherein f1=−16.09 mm; f2=−7.31 mm; f3=9.97 mm; f4=19.59 mm; f5=−18.61 mm; f6=13.69 mm; f7=18.45 mm; f23=−50.76 mm; f56=151.93 mm; fg1=23.92; fg2=20.73 mm.

Additionally, based on the above detailed parameters, detailed values of the aforementioned conditional formula in the third embodiment are as follows: F/f1=−0.54; F/f23=−0.17; F/f3=0.87; F/f4=0.44; F/f56=0.06; F/f6=0.64; F/f7=0.47; F/fg1=0.36; F/fg2=0.42.

With the aforementioned design, the first optical assembly C1 to the fifth optical assembly C5 satisfy the aforementioned conditions (1) to (6) of the optical imaging lens 300.

Moreover, an aspheric surface contour shape Z of each of the object-side surface S1 of the first lens L1, and the image-side surface S2 of the first lens L1, and the object-side surface S13 of the seventh lens L7, and the image-side surface S14 of the seventh lens L7 of the optical imaging lens 300 according to the third embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, and the image-side surface S2 of the first lens L1, and the object-side surface S13 of the seventh lens L7, and the image-side surface S14 of the seventh lens L7 of the optical imaging lens 300 according to the third embodiment and the different order coefficient of A4, A6, A8, A10, A12, A14, and A16 are listed in following Table 6:

TABLE 6

| Surface | S1 | S2 | S13 | S14 |
|---|---|---|---|---|
| k | 0 | 0 | 0 | 0 |
| A4 | −3.2258E−04 | −3.2526E−04 | −3.3008E−04 | −2.3964E−04 |
| A6 | −2.3615E−05 | −2.2711E−05 | −2.1617E−05 | −9.5087E−06 |
| A8 | 1.9784E−06 | 1.8402E−06 | 1.6616E−06 | 1.7846E−06 |
| A10 | −1.6587E−07 | −1.5490E−07 | −1.3915E−07 | −2.4365E−07 |
| A12 | 6.8708E−09 | 6.4051E−09 | 5.6791E−09 | 1.4005E−08 |
| A14 | −1.4538E−10 | −1.3538E−10 | −1.1868E−10 | −3.9521E−10 |
| A16 | 1.1712E−12 | 1.0862E−12 | 9.3435E−13 | 4.0989E−12 |

Taking optical simulation data to verify the imaging quality of the optical imaging lens 300, wherein FIG. 3B is a diagram showing the longitudinal spherical aberration according to the third embodiment; FIG. 3C is a diagram showing the lateral spherical aberration according to the third embodiment. The graphics shown in FIG. 3B and FIG. 3C are within a standard range. In this way, the optical imaging lens 300 of the third embodiment could effectively enhance image quality.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly comprising, in order from the object side to the image side along the optical axis, a first optical assembly having negative refractive power, a second optical assembly having negative refractive power, and a third optical assembly having positive refractive power;
an aperture;
a second lens assembly comprising, in order from the object side to the image side along the optical axis, a fourth optical assembly having positive refractive power and a fifth optical assembly having positive refractive power;
wherein two of the first optical assembly, the second optical assembly, the third optical assembly, the fourth optical assembly, and the fifth optical assembly comprise a compound lens formed by adhering at least two lenses, while the others are single lenses.

2. The optical imaging lens as claimed in claim 1, wherein the first optical assembly is a single lens that comprises a first lens; the second optical assembly is a compound lens that comprises a second lens and a third lens; the third optical assembly is a single lens that comprises a fourth lens; the fourth optical assembly is a compound lens that comprises a fifth lens and a sixth lens; the fifth optical assembly is a single lens that comprises a seventh lens.

3. The optical imaging lens as claimed in claim 2, wherein the optical imaging lens satisfies: −0.6<F/f1<−0.4, wherein F is a focal length of the optical imaging lens; f1 is a focal length of the first lens.

4. The optical imaging lens as claimed in claim 2, wherein the optical imaging lens satisfies: −0.25<F/f23<−0.1, wherein F is a focal length of the optical imaging lens; f23 is a focal length of the compound lens formed by adhering the second lens and the third lens.

5. The optical imaging lens as claimed in claim 4, wherein the optical imaging lens satisfies: 0.6<F/f3<0.9, wherein F is the focal length of the optical imaging lens; f3 is a focal length of the third lens.

6. The optical imaging lens as claimed in claim 2, wherein the optical imaging lens satisfies: 0.3<F/f4<0.5, wherein F is a focal length of the optical imaging lens; f4 is a focal length of the fourth lens.

7. The optical imaging lens as claimed in claim 2, wherein the optical imaging lens satisfies: 0.01<F/f56<0.15, wherein F is a focal length of the optical imaging lens; f56 is a focal length of the compound lens formed by adhering the fifth lens and the sixth lens.

8. The optical imaging lens as claimed in claims 7, wherein the optical imaging lens satisfies: 0.55<F/f6<0.7, wherein F is the focal length of the optical imaging lens; f6 is a focal length of the sixth lens.

9. The optical imaging lens as claimed in claims 7, wherein the optical imaging lens satisfies: 0.3<F/f7<0.5, wherein F is the focal length of the optical imaging lens; f7 is a focal length of the seventh lens.

10. The optical imaging lens as claimed in claims 1, wherein the optical imaging lens satisfies: 0.2<F/fg1<0.4, wherein F is a focal length of the optical imaging lens; fg1 is a focal length of the first lens assembly.

11. The optical imaging lens as claimed in claims 1, wherein the optical imaging lens satisfies: 0.3<F/fg2<0.5, wherein F is a focal length of the optical imaging lens; fg2 is a focal length of the second lens assembly.

12. An optical imaging lens, in order from an object side to an image side along an optical axis, comprising:
a first lens having negative refractive power, wherein an object-side surface of the first lens and/or an image-side surface of the first lens are/is an aspheric surface;
a second lens, which is a biconcave lens with negative refractive power;
a third lens having positive refractive power, wherein an object-side surface of the third lens and an image-side surface of the second lens are adhered to form a compound lens;
an aperture;
a fourth lens having positive refractive power;
a fifth lens having negative refractive power, wherein an object-side surface of the fifth lens is a convex surface, and an image-side surface of the fifth lens is a concave surface;
a sixth lens, which is a biconvex lens with positive refractive power; and
a seventh lens having positive refractive power, wherein an object-side surface of the seventh lens and/or an image-side surface of the seventh lens are/is an aspheric surface.

13. The optical imaging lens as claimed in claim 12, wherein the object-side surface of the first lens is a convex surface, and the image-side surface of the first lens is a concave surface.

14. The optical imaging lens as claimed in claim 12, wherein the third lens is a biconvex lens.

15. The optical imaging lens as claimed in claim 12, wherein the fourth lens is a biconvex lens.

16. The optical imaging lens as claimed in claim 12, wherein the seventh lens is a biconvex lens.

17. The optical imaging lens as claimed in claim 12, wherein both of the object-side surface of the first lens and the image-side surface of the first lens are aspheric surfaces.

18. The optical imaging lens as claimed in claim 12, wherein both of the object-side surface and the image-side surface of the seventh lens are aspheric surfaces.

19. The optical imaging lens as claimed in claim 12, wherein the optical imaging lens satisfies: −0.6<F/f1<−0.4, wherein F is a focal length of the optical imaging lens; f1 is a focal length of the first lens.

20. The optical imaging lens as claimed in claim 12, wherein the optical imaging lens satisfies: −0.25<F/f23<−0.1, wherein F is a focal length of the optical imaging lens; f23 is a focal length of the compound lens formed by adhering the second lens and the third lens.

21. The optical imaging lens as claimed in claim 12, wherein the optical imaging lens satisfies: 0.6<F/f3<0.9, wherein F is a focal length of the optical imaging lens; f3 is a focal length of the third lens.

22. The optical imaging lens as claimed in claim 12, wherein the optical imaging lens satisfies: 0.3<F/f4<0.5, wherein F is a focal length of the optical imaging lens; f4 is a focal length of the fourth lens.

23. The optical imaging lens as claimed in claim 12, wherein the optical imaging lens satisfies: 0.01<F/f56<0.15, wherein F is a focal length of the optical imaging lens; f56 is a focal length of a compound lens formed by adhering the fifth lens and the sixth lens.

24. The optical imaging lens as claimed in claim 12, wherein the optical imaging lens satisfies: 0.55<F/f6<0.7, wherein F is a focal length of the optical imaging lens; f6 is a focal length of the sixth lens.

25. The optical imaging lens as claimed in claim 12, wherein the optical imaging lens satisfies: 0.3<F/f7<0.5, wherein F is a focal length of the optical imaging lens; f7 is a focal length of the seventh lens.
